(19) United States
(12) Patent Application Publication
(10) Pub. No.: US 2002/0069135 A1
(43) Pub. Date: Jun. 6, 2002

(54) Multi-dimensional order making and receiving business matching system

(76) Inventors: Shizuo Kondo, Tokyo (JP); Yasuhiro Senda, Tokyo (JP); Masakatsu Nakagawa, Fujisawa-shi (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/038,731

(22) Filed: Dec. 31, 2001

(30) Foreign Application Priority Data
Jul. 11, 2000 (JP) P2000-210428

(51) Int. Cl. G06F 17/60

(52) U.S. Cl. 705/26

(57) ABSTRACT

A multi-dimensional order making and receiving business matching system for matching a want-to-buy business and a want-to-sell business selected among from a number of want-to-sell businesses in the Internet is described. The matching system comprising a multi-dimensional space as defined with a plurality of variables in order to identify the work content of the want-to-sell business to be matched, and a database which is configured to be accessed in correspondence with the respective points of the multi-dimensional space. The work information of a want-to-sell business is registered in the multi-dimensional order making and receiving business matching system by registering the work information in correspondence with one of the respective points of the multi-dimensional space. The work information of the want-to-sell business to be matched is accessed by searching the database with values which are given to the respective variables of the multi-dimensional space.

### BACKGROUN OF THE INVENTION

1. Field of the Invention

The present invention relates to a multi-dimensional order making and receiving business matching system for matching a want-to-buy business and a want-to-sell business selected among from a number of want-to-sell businesses in the Internet.

2. Description of the Related Art

At the present time, the Internet business is one of the core terms of IT (Information Technology) and has been globally developing in the world. However, the Internet business is based on homepages in which business enterprises or corporations provide information of their items of sales or services, for example, as a business mall in which the user can search for his desired items of sales or services. While this is substantially effective in convenience and cost reduction and therefore these services are sharply increased, the currently available systems have limitations.

Namely, in the case of the currently available systems, the user first opens the homepage of a maker, obtains necessary information from the homepage, and then if necessary purchases his favorite commodity therefrom. In this case, it is possible to easily obtain necessary information and purchase any items of sales or services therefrom.

However, in the case of B to B (Business to Business), i.e., in the case where a company sells products or provides services to other companies, the above conventional business model can not effectively work in the Internet. The company (want-to-sell company) providing services or commodities via the Internet has to simply wait for a chance that the homepage is found by other companies (want-to-buy company) looking for such services or commodities. Accordingly, it is difficult for a want-to-sell company to find a want-to-buy company, even if there is such a want-to-buy company looking for services or commodities of the want-to-sell company. In other words, in the case of the currently available systems by the nature of the Internet, a want-to-sell company shall take a passive position.

On the other hand, it is difficult in the Business to Business environment to effectively develop the business plan unless identifying a most appropriate want-to-buy company. Namely, a new active business model is needed for allowing a want-to-sell to company pinpoint a most appropriate want-to-buy company. It is therefore important how to match a want-to-sell company to a corresponding want-to-buy company. For this purpose, the order item and the order condition of a want-to-sell company have to be taken into consideration.

In the case where a business is developed through the Internet, while there is a need for such a service enabling the business to pinpoint a most appropriate company in the Internet, the potential of the Internet is not fully developed for this purpose in the case of the existing B2B matching systems.

The existing Internet businesses have made use of the Internet only through accessing the respective homepages in order to search for necessary information for the businesses. However, the large portion of companies desiring the use of the Internet business have no information about how to select an appropriate want-to-buy company. In other words, it is not expected to fully activate the businesses unless a want-to-sell companies can be matched with a want-to-buy company in a pinpoint manner.

In fact, while the market competition in the current low growth period becomes extremely severe, it is required to select flexible options coping with the situation where cooperation groups in the form of vertical pyramids have collapsed to accelerate the trend toward horizontal and interprofessional flexible grouping.

To this end, effective matching among various corporations has not been established as required by the Business to Business environment in the Internet, partly because the vertical pyramids are fixedly operating while there are a very large number of want-to-sell companies and a very large number of want-to-buy companies which are sometimes interlinked with extremely complicated and conflicting interests. Moreover, it becomes difficult to find optimal grouping a very large number of want-to-sell companies and a very large number of want-to-buy companies because of the lack of an effective business model capable of sorting and arranging a very large number of companies in order to resolve the difficulties from the ground up. In the current sluggish growth economy period, the vertical pyramids of cooperation groups have collapsed resulting in transition to horizontal grouping for intergroup transaction giving environmental considerations.

In this background, the present invention has been made to meet the demand particularly from the want-to-sell companies including medium and small manufacturing companies.

### BRIEF SUMMARY OF THE INVENTION

In brief, the above and other objects and advantages of the present invention are provided by a multi-dimensional order making and receiving business matching system for matching a want-to-buy business and a want-to-sell business selected among from a number of want-to-sell businesses in the Internet, said system comprising:

a multi-dimensional space as defined with a plurality of variables in order to identify the work content of the want-to-sell business to be matched; and

a database which is configured to be accessed in correspondence with the respective points of said multi-dimensional space,

wherein work information of a want-to-sell business is registered in said multi-dimensional order making and receiving business matching system by registering said work information in correspondence with one of the respective points of said multi-dimensional space, and

wherein said work information of the want-to-sell business to be matched is accessed by searching said database with values which are given to the respective variables of said multi-dimensional space.

In accordance with another aspect of the present invention, there is established a members only network through which member companies are linked to each other as said want-to-buy business and said want-to-sell business.

In accordance with a further aspect of the present invention, said work information of said want-to-sell businesses is registered in the form of business electric brochures in accordance with a common format.

In accordance with a further aspect of the present invention, said variables of said multi-dimensional space include the name of the field, the name of the economic segment, the name of the product or the name of the process.

In accordance with a further aspect of the present invention, said name of the field and said name of the economic segment are defined on the basis of the standardized common supplier code system.

In accordance with a further aspect of the present invention, said name of the product is defined by the use of the standardized tariff code system on the basis of the international customs convention.

In accordance with a further aspect of the present invention, said name of the product is classified on the basis of the standardized product process code system.

In accordance with a further aspect of the present invention, at least one of said variables of said multi-dimensional space includes a hierarchical structure.

### BRIEF DESCRIPTION OF THE SEVERAL VIEWS OF THE DRAWINGS

The aforementioned and other features and objects of the present invention and the manner of attaining them will become more apparent and the invention itself will be best understood by reference to the following description of various embodiments of the present invention taken in conjunction with the accompanying drawings, wherein:

FIG. 1 is an explanatory view for explaining the overall configuration of a multi-dimensional order making and receiving business matching system in accordance with the present embodiment.

FIG. 2 is a schematic diagram showing one example of the common format to describe the work description of a want-to-buy company in accordance with the multi-dimensional order making/receiving matching system of the present invention.

FIG. 3 is a schematic diagram showing database objects which are searched as points in the three-dimensional space located by an X axis corresponding to the standardized common supplier code, a Y axis corresponding to the standardized tariff code system and a Z axis corresponding to the standardized product process code system in accordance with the multi-dimensional order making/receiving matching system of the present invention.

FIG. 4 is a schematic diagram showing an example of a two-dimensional matrix formed by the name of the field or the economic segment and the name of the process or the product in accordance with the multi-dimensional order making/receiving matching system of the present invention.

FIG. 5 is a schematic diagram showing the hierarchical structure of the database object DB of the business matrix model system in accordance with the multi-dimensional order making/receiving matching system of the present invention.

### DETAILED DESCRIPTION OF THE INVENTION

In the followings, various embodiments of the present invention will be described with reference to the accompanying drawings.

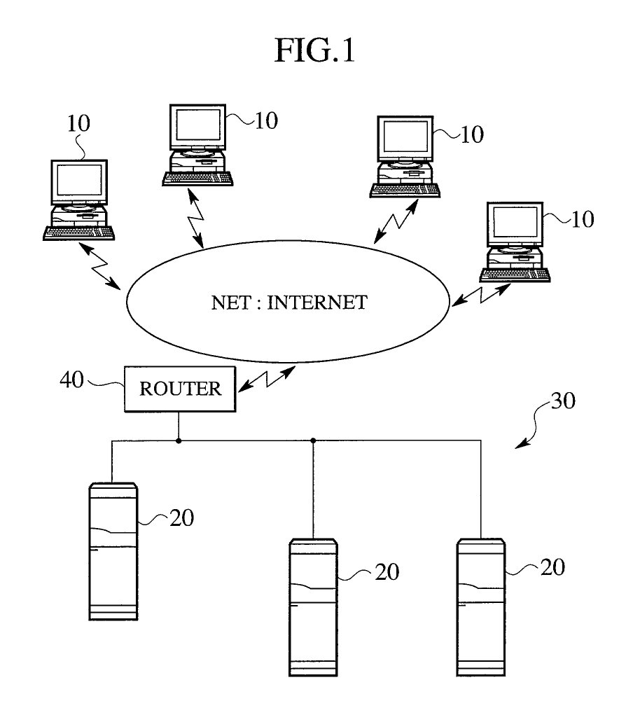

FIG. 1 is an explanatory view for explaining the overall configuration of a multi-dimensional order making and receiving business matching system in accordance with the present embodiment. In this case, it is assumed that the multi-dimensional order making and receiving business matching system is provided for members only and a non-member company can participate after registered as a member. At the present, this type of member's network is most efficient in terms of productivity. However, in time to come, it will be possible to implement the system as a network open to public.

In the figure, the Internet is the network on which the multi-dimensional order making and receiving business matching system in accordance with the present invention is implemented and through which are connected server or client terminals 10 of the respective members. Also, the multi-dimensional order making and receiving business matching system in accordance with the present embodiment is composed generally of a plurality of servers 20 each of which is connected to the Internet through a LAN (LOCAL AREA NETWORK) 30 and a router 40. In the following description, the respective servers will be explained in details.

First, the servers 20 include a member database server which is provided with a member database in which is stored member information about the respective members of the multi-dimensional order making and receiving business matching system in accordance with the present embodiment. Also, the servers 20 include a web server which is connected to the member database server in order to update the member information and provide a front engine for the information search process. The web server then serves to return the unit(s) of information relating to an optimal want-to-buy company (companies) in response to the request from a member as a want-to-sell company (companies) as explained in the following description.

Next, the procedure for matching a want-to-buy company with a want-to-buy company (companies) will be explained. At first, a company making use of the multi-dimensional order making and receiving business matching system accesses to a new member registration page stored in the web server of the multi-dimensional order making and receiving business matching system. The company inputs necessary information required for the registration to the new member registration page. Items of such information required for the registration are selected among from, for example, the name of the company, the president of the company, the resident address, the telephone number, the facsimile number, the e-mail address, the URL, the line of manufacturing work, the type of manufacturing/processing, the products, the sales scale, the bank of account and so forth. Some of the items may not be indispensable.

When the company selects the registration button after inputting the information as required, the information is registered in the member database and the company is given a member ID and a password for use in accessing the member-only pages. The procedure as described above is implemented with a CGI program, an SSL program and the like provided within the web server of the multi-dimensional order making and receiving business matching system. In the member-only pages, it is possible to modify or delete the contents of the information as registered.

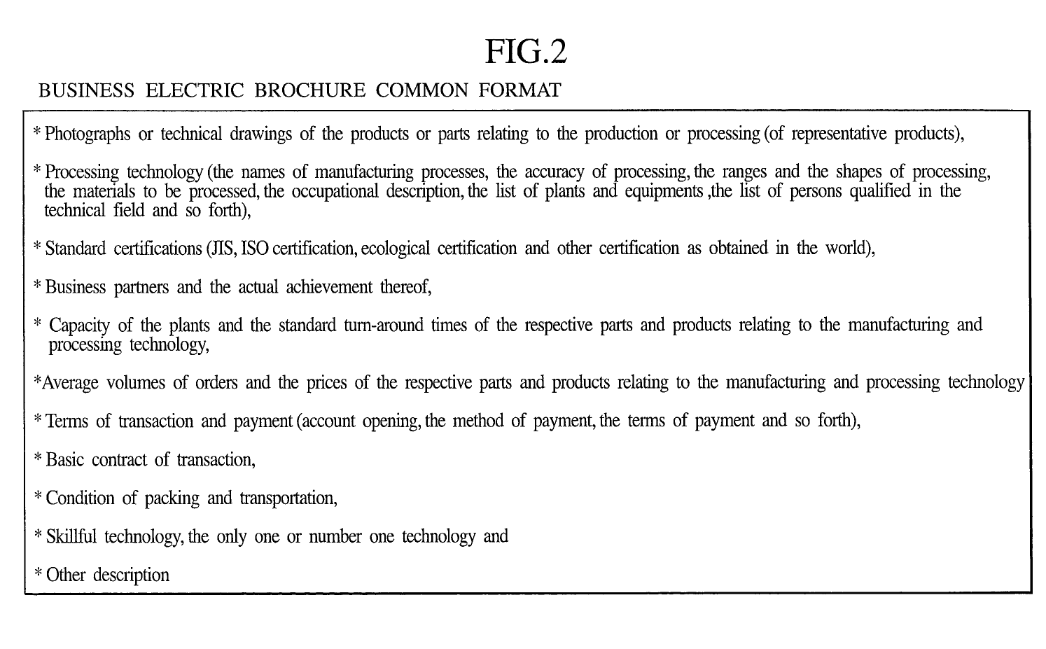

Particularly, the multi-dimensional order making and receiving business matching system in accordance with the present embodiment allows want-to-buy companies to register business electric brochures. Namely, the work description of a want-to-buy companies is registered in a common format as a business electric brochure. FIG. 2 is a schematic diagram showing one example of the common format to describe the work description of a want-to-buy company. The common format includes a number of fields (entries), i.e., photographs or technical drawings of the products or parts relating to the production or processing (of representative products), the processing technology (the names of manufacturing processes, the accuracy of processing, the ranges and the shapes of processing, the materials to be processed, the occupational description, the list of plants and equipments, the list of persons qualified in the technical field and so forth), the standard certifications (JIS, ISO certification, ecological certification and other certifications as obtained in the world), the business partners and the actual achievement thereof, the capacity of the plants and the standard turn-around times of the respective parts and products relating to the manufacturing and processing technology, the average volumes of orders and the prices of the respective parts and products relating to the manufacturing and processing technology, the terms of transaction and payment (account opening, the method of payment, the terms of payment and so forth), the basic contract of transaction, the condition of packing and transportation, the skillfull technology, the only one or number one technology, and other description.

The common format is described in XML and transferred to a directory as designated in the member database server by FTP. The member ID and the password for use in the transfer are the member ID and the password of the multi-dimensional order making and receiving business matching system. Particularly, one point of a multi-dimensional space as described in the followings has to be designated together with said common format in the XML file.

The multi-dimensional space is defined by a plurality of variables which are used as search terms for the purpose of identifying the work content of a want-to-buy company (companies). Generally speaking, while the multi-dimensional space is a two or more dimensional space, a higher order of dimension makes it possible to search with a higher accuracy but makes it difficult and cumbersome to register want-to-buy companies. Meanwhile, it is preferred that the respective variables have little or no correlation with each other.

As an actual example, a three dimensional space will be described. The first variable of the three-dimensional space is the name of the field or the name of the economic segment. This variable can take for example the car industry, the electric industry and the like, each of which is divided into subcategories such as the trucks, the light motor vehicles, the consumer electronics, the heavy electric machineries and the like, each of which may be further divided in a hierarchically structure. Namely, one variable can be hierarchically structured, for example, to have a major division, an intermediate division and a minor division. This is defined on the basis of the standardized common supplier code system.

The second variable of the three-dimensional space is the name of the product. This is defined by the use of the standardized tariff code system on the basis of the international customs convention. The third variable of the three-dimensional space is the name of the process as classified as the standardized product process code system. Namely, the type of processing items is identified, for example, about manufacturing, assembling, fabricating, improving, shaping and so forth. This variable can also be hierarchically structured, for example, to take a major division, an intermediate division and a minor division. The XML file as described above is interactively generated and transferred to the directory as designated in the member database server by an exclusive FTP program.

The member database server serves to generate and maintain a database object for each point of the multi-dimensional space by parsing and analyzing the respective XML files as input to said each point. In the case of this embodiment, the respective database objects are independent from each other. Namely, the database objects are provided in a one-to-one correspondence with the respective points of the multi-dimensional space. Needless to say, in the case where an alias is introduced for a variable of the multi-dimensional space, the one-to-one correspondence is formally violated. However, this is not essential. Also, all the database objects can aggregately be packed in the form of an equivalent single database object in which may be provided a cross search engine enabling to search the respective databases at once for a company (companies) meeting to a retrieval requirement as given.

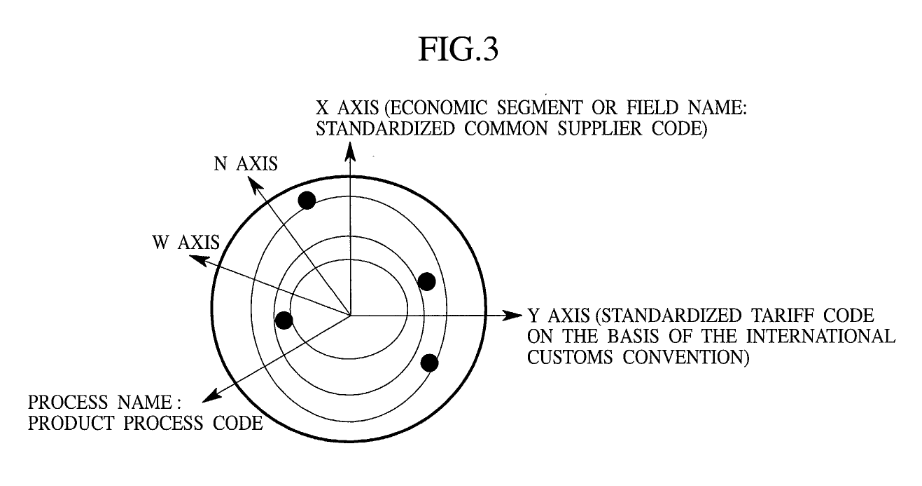

FIG. 3 is a schematic diagram showing database objects which are searched as points in the three-dimensional space located by an X axis corresponding to the standardized common supplier code, a Y axis corresponding to the standardized tariff code system and a Z axis corresponding to the standardized product process code system. As shown in the figure, an N axis and a W axis may be introduced to make the space five-dimensional.

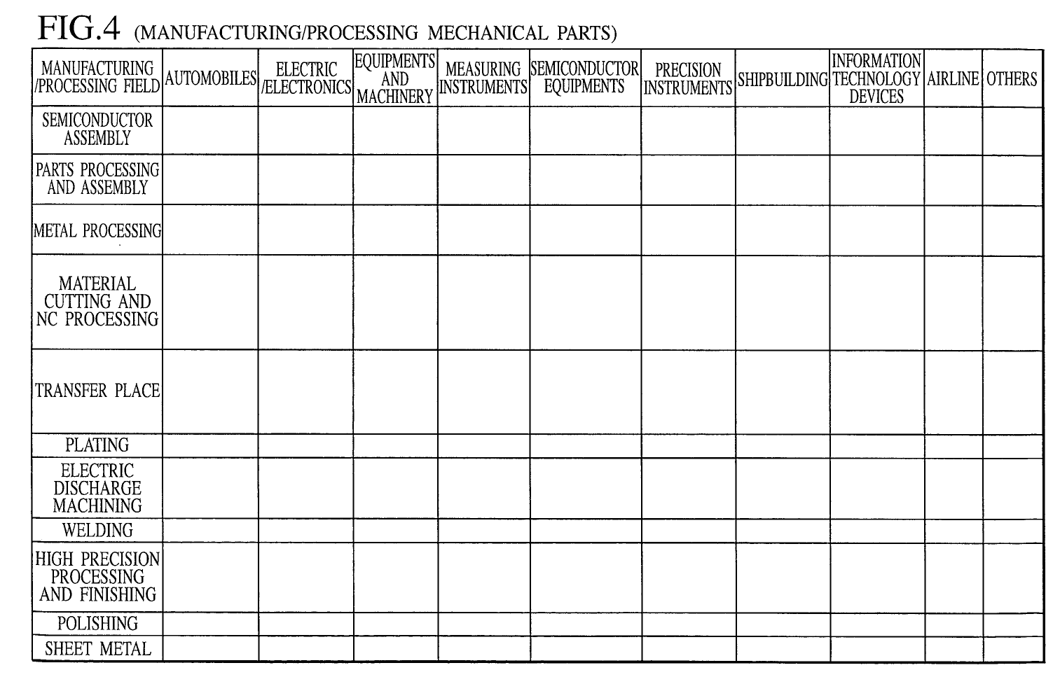

Since the multi-dimensional space of this embodiment as described above is discrete, the system can be called as a business matrix model system. In the case of the above described embodiment, the multi-dimensional order making and receiving business matching system is formed on the basis of a three-dimensional matrix. FIG. 4 is a schematic diagram showing an example of a two-dimensional matrix formed by the name of the field or the economic segment and the name of the process or the product. In this case, the two-dimensional matrix is related to the field of manufacturing/processing mechanical parts. Namely, the possible values of the name of the field or the economic segment include, as the names of the manufacturing/processing field, automobiles, electric/electronics, equipments, measuring instruments, semiconductor equipments, precision instruments, shipbuilding, information technology devices, airline and others.

Also, the possible values of the name of the process or the product include semiconductor assembly, parts processing and assembly, metal processing, material cutting and NC processing, transfer place, plating, electric discharge machining, welding, high precision processing finishing, polishing and sheet metal. In an actual implementation of the database, a pointer to a corresponding database object is given to the point of the matrix.

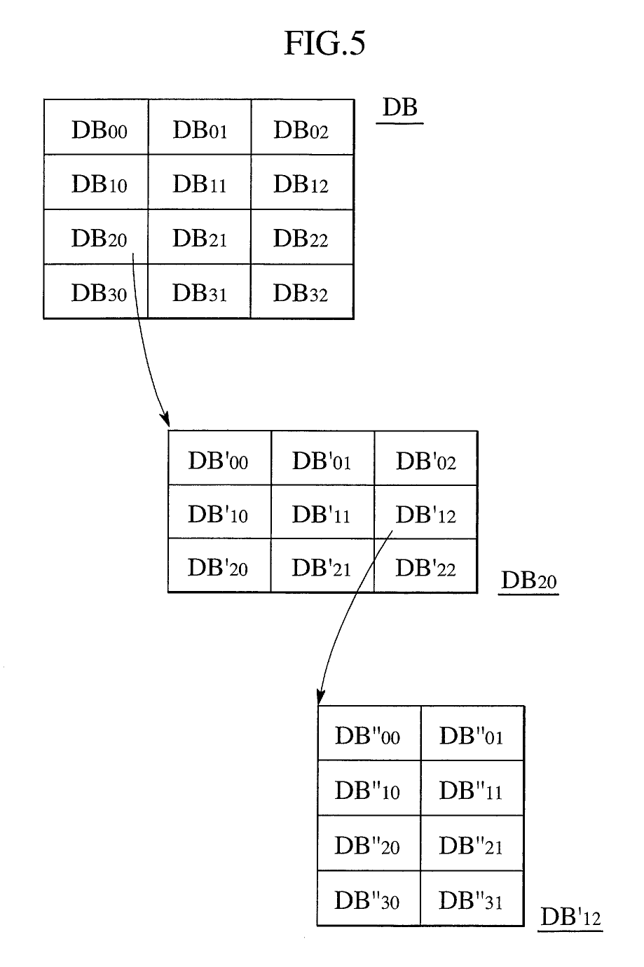

The matrix consisting of the database objects, or the pointers thereto has a plurality of hierarchies. FIG. 5 is a schematic diagram showing the hierarchical structure of the database object DB of the business matrix model system. As shown in the figure, the respective elements of the matrix are major divisions DBnn each of which consists of a plurality of database objects DBnn′ in a lower layer constituting intermediate divisions, each of which again consists of a plurality of database object DBnn″ in a lower layer constituting minor divisions. Needless to say, while the three-layered structure including the major divisions, the intermediate divisions and the minor divisions is simply exemplary, a deeper hierarchical structure or a two-dimensional matrix can be implemented in the same manner.

Next, the procedure of searching for a want-to-sell company (companies) by a want-to-buy company will be explained. First, when accessing the web server of the system, a page indicative of verifying the membership of the user is opened. The web server then accesses to the cookie inside of the computer of the user and, if verifying the membership of the user, a search page for searching information is automatically opened. When the membership is not confirmed by means of the cookie, a user authorization and registration page is opened. If the user is a member, an ID and a password are input. If the user is not a member, he takes necessary steps for registration of membership in the registration page.

In the search page, the user designates a point of the three-dimensional matrix by inputting the respective values in accordance with the standardized common supplier code system, the standardized tariff code system and the standardized product process code system. After clicking a search button, the corresponding database object is accessed to browsing the list of the corresponding companies. The respective values may be input in accordance with any hierarchy of the hierarchical structure such as a major division, an intermediate division and a minor division. After browsing the list of the corresponding companies, a lower hierarchy may be designated if necessary for improving the accuracy.

The information of any of the corresponding companies can quickly be referred to in details in the prescribed form by clicking that company. Also, there is a link to the URL of that company so that the user can directly access to the homepage of that company. Alternatively, the user can repeat the range search operation of searching the corresponding companies for more appropriate companies. This range search is conducted by accessing the corresponding database object with an information retrieval requirement. The database is constructed to include business electric brochures in the form of a common format so that it is possible to effectively conduct the search operation. Also, a full text search engine is provided for the database.

As explained above, in accordance with the embodiment of the present invention, it is possible to speed up a business management in the midst of on-going IT revolution. While the frequency ratio of the business agreement versus the access count is up to now extremely low such as 0.2% to 0.5%, it is predicted that the frequency ratio in accordance with the embodiment of the present invention is 80% or higher. By this configuration, the Internet business is significantly activated by the economic effects due to the present invention. The reliability and the serviceability of the Internet business is significantly improved by applying the present invention. Namely, unless the reliability of the system is sufficiently high, it is impossible to obtain the confidence of want-to-sell companies and the confidence of want-to-buy companies.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

What is claimed is:

1. A multi-dimensional order making and receiving business matching system for matching a want-to-buy business and a want-to-sell business selected among from a number of want-to-sell businesses in the Internet, said system comprising:
a multi-dimensional space as defined with a plurality of variables in order to identify the work content of the want-to-sell business to be matched; and
a database which is configured to be accessed in correspondence with the respective points of said multi-dimensional space,
wherein work information of a want-to-sell business is registered in said multi-dimensional order making and receiving business matching system by registering said work information in correspondence with one of the respective points of said multi-dimensional space, and
wherein said work information of the want-to-sell business to be matched is accessed by searching said database with values which are given to the respective variables of said multi-dimensional space.

2. The multi-dimensional order making and receiving business matching system as claimed in claim 1 wherein there is established a members only network through which member companies are linked to each other as said want-to-buy business and said want-to-sell business.

3. The multi-dimensional order making and receiving business matching system as claimed in claim 2 wherein said work information of said want-to-sell businesses is registered in the form of business electric brochures in accordance with a common format.

4. The multi-dimensional order making and receiving business matching system as claimed in claim 3 wherein said variables of said multi-dimensional space include the name of the field, the name of the economic segment, the name of the product or the name of the process.

5. The multi-dimensional order making and receiving business matching system as claimed in claim 4 wherein said name of the field and said name of the economic segment are defined on the basis of the standardized common supplier code system.

6. The multi-dimensional order making and receiving business matching system as claimed in claim 4 wherein said name of the product is defined by the use of the standardized tariff code system on the basis of the international customs convention.

7. The multi-dimensional order making and receiving business matching system as claimed in claim 4 wherein said name of the product is classified on the basis of the standardized product process code system.

8. The multi-dimensional order making and receiving business matching system as claimed in claim 4 wherein at least one of said variables of said multi-dimensional space includes a hierarchical structure.
